(19) United States
(12) Patent Application Publication
(10) Pub. No.: US 2026/0233815 A1
(43) Pub. Date: Aug. 13, 2026

(54) RESCUE CLAMP

(71) Applicant: Markus Dombois, Stockton, CA (US)

(72) Inventor: Markus Dombois, Stockton, CA (US)

(73) Assignee: DOMBOIS DESIGNS, INC., Stockton, CA (US)

(21) Appl. No.: 19/048,884

(22) Filed: Feb. 8, 2025

(51) Int. Cl. B63C 9/26; B25J 1/02

(52) U.S. Cl. CPC B63C 9/26; B25J 1/02

(57) ABSTRACT

The Rescue Clamp is composed of 1) a clamp, which is applied to a swimming or floating victim's torso, 2) an applicator pole and 3) a retrieval tether. This lightweight apparatus allows a single person to quickly apply the clamp to a victim or target in the water using the applicator pole, after which the applicator pole may be removed, and the victim may be situationally controlled and brought aboard or ashore using the retrieval tether.

### FIELD

This disclosure relates to rescue or retrieval of victims, i.e., man overboard (MOB) or other targets from the water, whether they are conscious, unconscious, or otherwise incapacitated.

### BACKGROUND

Embodiments of this disclosure overcome the need for deployment of complex MOB equipment to recover a victim or target from the water. The present device allows for rapid deployment and an efficient means to recover a victim from the water without a rescuer needing to enter the water, whether the victim is conscious, unconscious, or otherwise incapacitated. This is especially important in frigid waters or adverse sea conditions. Once a victim has fallen in the water, particularly in frigid temperatures, it is of crucial importance to recover the victim as quickly as possible. A quick retrieval will increase the likelihood of survival for the victim. This apparatus fulfills a long-felt need in the maritime industry or recreational space, including application in ice-bound waters.

### SUMMARY

Disclosed herein are aspects, features, elements, and implementations for rescuing and/or retrieval of victims in “man overboard” (MOB) scenarios.

In an implementation for water rescue, an apparatus is disclosed comprising 1) a clamp composed of at least two portions. 2) A releasably attachable applicator pole. 3) The applicator pole being releasably attachable to the clamp; and 4) a retrieval tether connected to the clamp. The “releasably attachable applicator pole” is combined with two spring-back flexible battens, hereinafter simply “applicator pole.”

In at least one embodiment, at least two curved clamp components defining a hinged clamp each have at least one male latch portion and at least one female latch portion. These are respectively attached to each distal end of the at least two elongated curved components defining a clamp.

In at least one embodiment the clamp is composed of at least two generally equal length elongated curved clamp components. These are connected by at least one hinge and are curved to form a circle or an ellipse, which when secured by at least one male latch portion and at least one female latch portion form a clasp. A retrieval tether is connected to the clamp near the at least one hinge.

In at least one embodiment, the clamp is composed of two equal length elongated curved clamp components that may be both padded and buoyant. These components are connected by at least one hinge. The two equal length elongated curved clamp components are curved to form a circle or an ellipse when secured by a clasp. A retrieval tether is connected to the clamp near the at least one hinge.

In at least one embodiment, the clamp is composed of multiple elongated clamp component members that are operable using an applicator pole attachable at or near hinged proximal ends of the multiple elongated clamp components, actuating a single mechanism composed of a combination of semiflexible battens configured to mate with the multiple elongated clamp components hinged at their proximate ends forming latching portions that are latched with a clasp at their distal ends with a retrieval tether connected near the hinged proximal ends of the clamp components. In at least one embodiment, pushing the hinged portion of the clamp against an object will apply a force conveying closing element to the portions of the clamp.

In at least one embodiment, a portion of the proximal end of the releasably attachable pole comprises a textual layer on the exterior surface.

In at least one embodiment, at least two elongated members forming two spring-back battens are attached to the applicator pole. These create a force conveying element providing a closing force to the clamp composed of the two equal length elongated curved clamp components. These components are hinged and curved to form a circle or an ellipse when secured by a clasp.

In at least one embodiment, two elongated members which are spring-back flexible are attached to a fixture that is removably attached to the applicator pole; provide a force conveying element applying a closing force to the clamp composed of the two equal length elongated curved clamp components that are hinged and curved and form a circle an ellipse when secured by a clasp.

In at least one embodiment, the at least two elongated members which are spring-back flexible are releasably inserted into sockets mounted on outside radiuses of the first two equal length elongated curved clamp components that are hinged and curved and form a circle or an ellipse when secured by a clasp.

In at least one embodiment, the at least two elongated members which are spring-back flexible, are pre-curved and tensioned to provide a force conveying element applying an additional closing force to first two equal length elongated curved clamp components that are hinged and curved and form a circle or an ellipse when secured by the clasp.

In at least one embodiment, the releasably attachable pole may be extended through a series of additional extender-poles that can be releasably attached to the proximal end of the applicator pole.

In at least one embodiment, an orthogonal grasping handle is (i) attached to the distal end of the releasably attachable pole and is (ii) located near the connection of the proximal ends of the two spring-back flexible elongated members forming battens.

In at least one embodiment, the orthogonal grasping handle comprises a battery container with a light.

In at least one embodiment, the substantially orthogonal grasping handle comprises a battery container with a light that is activated by a water-actuated switch.

In another implementation for water rescue, an apparatus is disclosed comprising: a clamp that is releasably attached to an applicator pole the clamp composed of at least one first long curved elongated member forming a hook shaped clamp body with a first end, attached to a hinge, and a second end with a latch receiver, wherein the clamp is further composed of at least one second elongated member forming a latching arm attached to the hinge with a third end, and a fourth end forming a latch bolt or latch tongue a retrieval tether attached to the latching arm at the third end, providing a force conveying element to the latching arm. In at least one embodiment, the retrieval tether leads from the clamp to at least one quick-release guide point on the releasably attachable applicator pole nearest the distal end of the textual layer.

In another implementation for water rescue, an apparatus is comprising a clamp composed of at least three elongated component members; the three elongated components hinged at their proximate ends and forming latching portions at their distal ends; an applicator pole attached at or near the hinged proximate ends of the three elongated components. A retrieval tether is attached near the hinged proximate ends of the at least three elongated clamp components.

In at least one embodiment, the applicator pole connected to at three battens that are releasable attachable to sockets mounted on the outside radiuses of at least three elongated clamp components. The at least three elongated curved clamp components are hinged and curved and form a circle a “grapple” when secured by the clasp. A grapple is a basket that is formed by an enclosing a series of hinged claws that may be seen in the use of some cranes designed to pick up and move boulders. In addition, a retrieval tether is attached at or near the hinged proximate ends of the at least three elongated component members.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure. This patent or application file contains at least one drawing executed in color. Copies of this patent or patent application publication with color drawings will be provided by the U.S. Patent and Trademark Office upon request and payment of the necessary fee.

FIG. 1 illustrates a top-down view of a rescue clamp apparatus showing both the proximal end that would be held by an operator and the distal working parts of the apparatus.

FIG. 2 illustrates head on view of a rescue clamp apparatus as it appears from behind a non-visible victim.

FIG. 3 illustrates a right-side view of the distal end of a rescue clamp apparatus.

FIG. 4A illustrates a top-down view of the distal end of a rescue clamp apparatus with the clamp portion in an open position.

FIG. 4B illustrates a top-down view of the distal end of a rescue clamp apparatus with the clamp portion in a closed position.

FIG. 5A illustrates a top-down view of the distal end of a rescue clamp apparatus with the clamp portion in an open position.

FIG. 5B illustrates a top-down view of the distal end of a rescue clamp apparatus with the clamp portion in a closed position.

FIG. 6A illustrates a top-down view of the distal end of a rescue clamp apparatus with the clamp portion in an open position.

FIG. 6B illustrates a top-down view of the distal end of a rescue clamp apparatus with the clamp portion in an open position.

FIG. 6C illustrates a top-down view of the distal end of a rescue clamp apparatus with the clamp portion in an open position.

FIG. 6D illustrates a top-down view of the distal end of a rescue clamp apparatus with the clamp portion in an open position.

FIG. 6E illustrates a top-down view of the clamp portion of a rescue clamp apparatus encircling a victim as they are beginning to be hoisted from the water on a retrieval tether.

FIG. 7A illustrates a top-down view of the distal end of a rescue clamp apparatus with the clamp portion in an open position.

FIG. 7B illustrates a top-down view of the distal end of a rescue clamp apparatus with the clamp portion in a closed position.

FIG. 7C illustrates a top-down view of the clamp portion of a rescue clamp apparatus encircling a victim as they are beginning to be hoisted from the water on a retrieval tether.

### OVERVIEW

The present disclosure provides for a water rescue device that can be stored in the overhead (against the ceiling) of a maritime vessel of any type that may carry personnel or passengers aboard. Once a victim has fallen in the water, particularly in frigid temperatures, it is of crucial importance to recover the victim as quickly as possible. A quick retrieval will greatly increase the likelihood of survival for the victim. As used herein a “victim” may also refer to a subject or a target. The term “proximal” as used herein means closer to the operator of the rescue device, and the term distal means further or farthest from the operator.

The present apparatus solves the problem inherent in the use of the legacy devices which almost always require that a rescuer enter the water to assist in deployment of the device. While other devices that do not require water entry by an additional rescuer they require at least some assistance from the victim to properly deploy the device.

The present rescue device can be deployed with efficacy by a single rescuer safely from the deck of a vessel or safely from shoreside, with no risk to the operator. This device solves the problem inherent in the use of legacy devices which almost always requires that a rescuer enter the water to assist in deployment of the device. While other devices that do not require water entry by an additional rescuer require at least some assistance from a conscious victim to properly deploy the device. This lightweight device can be stored ready for quick deployment in the “overhead” of a vessel (E.g., against the ceiling of a passenger compartment), or on a stand or rack aboard the vessel. Or on the side of a wall in a shoreside application.

Additionally, the lightweight applicator pole can be temporarily placed on the deck of a vessel, while the victim is recovered at the end of the tether. On smaller vessels that have a swim-step or surface-level boarding platform at the transom of a vessel, the victim who is encircled by the latched clamp components may be guided astern to where they may be recovered via this swim-step or platform.

Other embodiments of this device may be used to solve other problems, for example: as a tool for capturing animals, or for retrieval of a victim from a well. Additionally, this device may be used to retrieve a victim who has fallen through ice.

Thus, this apparatus fulfills a long-felt need in the maritime industry or recreational space, including application in ice-bound waters.

According to the present disclosure, because of its light weight and simplicity of application, a crew member or passenger (or first responder) may be able to immediately deploy this device. This will aid in quickly rescuing a victim who has fallen into the water or should an unconscious or deceased person need to be recovered.

The vessel operator will need to maneuver the vessel within range. After which a single crewmember, with minimal training, will be able to use the applicator pole to attach the padded clamp to the victim. At this point, the victim may be encircled with a buoyant clamp and attached by a tether. The buoyant clamp may serve as a life preserver even when immediate recovery using the tether may be impracticable or impossible.

This differs from the legacy art since the vessel operator can now safely maneuver the vessel without the need to keep the victim directly alongside, thereby avoiding harm to the victim. The crew member or device operator will then be able to recruit other crew or passengers aboard the vessel to hoist the victim on board, using the attached tether.

In other embodiments and applications, the present apparatus may be used to apply floatation devices, lights, and/or location beacons to victims in the water, without anticipating immediate retrieval of the victims.

### DETAILED DESCRIPTION

The drawings described below are for illustration purposes only. The drawings are not intended to limit the scope of the present disclosure.

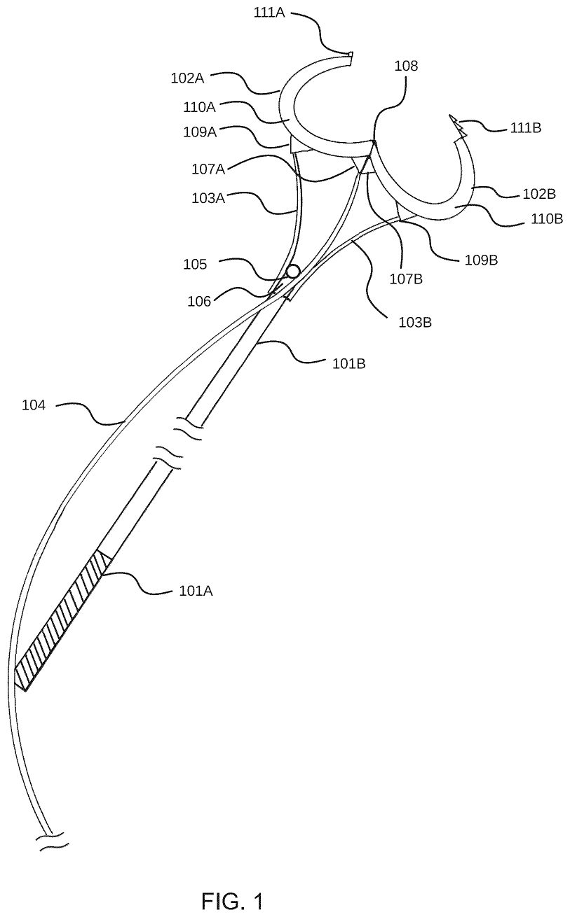

Referring now to FIG. 1, an exemplary lightweight applicator pole, composed of a proximate applicator pole portion with a textual layer 101A and a distal end of the applicator pole 101B is illustrated. The lightweight applicator pole may be of variable lengths. The “hinged elongated curved clamp components” (hereinafter “clamp components” or “clamp”), left-side component 102A and right-side component 102B are illustrated in an open position. These are two generally equal elongated clamp components, left-side component 102A and right-side component 102B. Battens of a spring-back flexible construction are shown, left-side batten 103A and right-side batten 103B. These may be attached to a removable applicator pole tip 106 on the distal end of the applicator pole 101B.

As depicted in this embodiment, a short orthogonal grasping handle 105 may be attached to a removable applicator pole tip 106. The battens that are shown attached to this removable applicator pole tip 106 may be configured to mate with the clamp as they are releasably inserted into two sockets, left-side socket 109A and right-side socket 109B. The sockets are shown affixed to the exterior radiuses of the fully opened clamp components, left-side component 102A and right-side component 102B.

A left-side stopper 107A and right-side stopper 107B are also depicted. These stoppers mandate a limiting range to the angle to which the clamp may be opened. Opposite to the stoppers is a clamp hinge 108, one of at least one clamp hinge mounted to the center of the inside radiuses of the clamp components. In other embodiments the clamp hinge 108 may be found on the outside of the clamp components. Also, in other embodiments there may be multiple clamp hinges in use.

With the clamp held open, and when the clamp hinge(s) is/are pushed against a resilient object (as with a human torso) the “spring back flexible battens” (hereinafter “battens”) that are inserted into the two sockets, left-side socket 109A and right-side socket 109B, will produce a force-conveying element to the clamp that will close it.

Located at the clamp component ends opposite to the applicator pole at the distal end of the applicator pole 101B are the two components of a latch. Composing a female portion 111A and male portion 111B, which may ratchet closed to fit the circumference of a victim as closely as possible. As used herein, a latch is any mechanical device that temporarily secures a first or male mechanical component to a second or female mechanical component forming a clasp. For example, a latch can be composed of a spring-activated ratchet buckle that serves to temporarily secure the first component of a clamp to the second component of a clamp. Or as may be apparent to those skilled in the art, the latch may also be magnetically assisted.

In some embodiments this latch may be positioned on the interior of the clamp components, instead of as depicted in FIG. 1. As depicted here, the ratchet buckle composed of female portion 111A and male portion 111B may be designed to tighten accordingly, to fit the circumference of the victim as snugly as possible. They should be latched before the applicator pole, composed of a proximate applicator pole portion with a textual layer 101A and a distal end of the applicator pole 101B, is removed.

Once the victim is enclosed in the clamp, composed of a left-side component 102A and a right-side component 102B, and the applicator pole is withdrawn, the victim may be recovered by use of the retrieval tether 104. The tether may be attached near or directly to the at least one hinge. The retrieval tether 104 is illustrated attached to the clamp which is in the open position with both the left-side stopper 107A and the right-side stopper 107B preventing the clamp from opening further.

Once the clamp hinge 108 is in contact with the victim, the retrieval tether 104 attached near the hinge may be pulled on to exert an additional counter force to aid in applying a closing force created by the battens, left-side 103A and right-side 103B. Doing this provides a closing force beyond the force exerted solely pushing the hinge against a victim's torso.

Once the clamp completely encircles the victim and is locked in place, the applicator pole, composed of a proximate applicator pole portion with a textual layer 101A and a distal end of the applicator pole 101B, may be removed together with the battens that were removably inserted into the sockets. The victim may then be retrieved with the retrieval tether 104. Optionally padding the insides of the clamp 110a and 110b may mitigate harm to the victim during retrieval. This application of appropriate padding will be apparent to those skilled in the art.

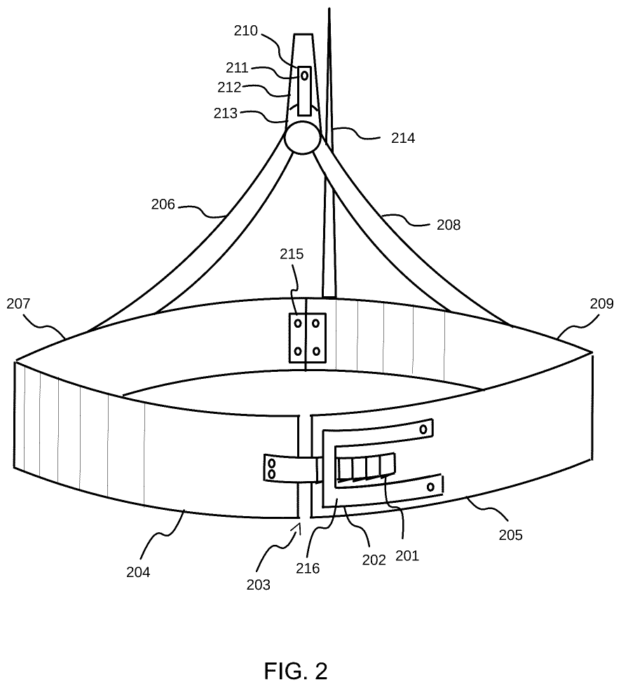

Referring now to FIG. 2. FIG. 2 is a view of the rescue clamp in a closed position from where it would be secured at the back of a victim's torso (victim not depicted). Those skilled in the art may implement the closure of the rescue clamp using any methodologies that are apparent to those skilled in the art.

For clarity of view, the exemplar clamps shown in this application are not shown as being padded with floatation materials. However, those skilled in the art may add padding and floatation materials that are apparent to those skilled in the art of floatation devices.

In some circumstances floatation material may be composed of buoyant bladder(s) that may be remotely inflated or triggered with trigger lines and inflated with pressurized gas cartridges.

In this exemplar device a spring-loaded rachet latch is illustrated. A male ratchet 201 portion of the clamp is shown inserted through a catch 216 such as a female portion of a ratchet receiver or a spring-loaded ratchet receiver 202, as shown. In some embodiments the catch 216 may be spring-loaded to be just flexible enough to allow the male ratchet 201 portion to pass underneath it yet prevent it from exiting. To release the catch, a rescuer can pull on the spring-loaded ratchet receiver 202 and thereby open the rescue clamp. The clamp may then be removed from a recovered victim (this spring-loaded receiver may be constructed of stainless steel, fiberglass, plastic, or carbon fiber or similar materials, along with the male rachet portion)

A gap 203 between the left-side clamp component 204 (around a victim's torso) and the right-side clamp component 205 exists because, as shown, the adjustable rachet mechanism of the male ratchet 201 portion is not fully inserted into the spring-loaded ratchet receiver 202. as it otherwise would be, in order to accommodate a larger torso than would be contained with a fully enclosed clamp.

The left-side batten 208 is removably inserted in a socket 207 (not visible but analogous to the sockets illustrated in FIGS. 1, 109A), while the clamp is in the fully locked position as demonstrated by the position of the clasp, composed of the male ratchet 201 portion and the catch 216. The right-side batten 206 is also inserted into a socket 209 located on the exterior radius of the clamp (not visible but analogous to the sockets illustrated in FIGS. 1, 109B).

FIG. 2 additionally shows the clamp sufficiently locked in place such that the applicator pole 212, and the battens are ready for removal and allow the victim at the end of the tether 214. The clamp in this drawing is secured by the two portions of the latch attached to distal ends of the curved clamp components. The clamp will maintain its closed and secured position because the spring-loaded ratchet receiver 202 portion of the latch may be made of a semi-flexible fiberglass, carbon or aluminum material that will hold its tension while in the open or the locked position, to avoid unlatching while the victim is being recovered.

Once the victim is securely latched within the rescue clamp, the applicator pole is removed along with the right-side batten 206 and the left-side batten which are illustrated attached to an optional removable tip 213. This removable tip may be threaded onto the end of the applicator pole, or held by a securing pin, or other means apparent to a person skilled in the art. At this point, the applicator pole 212, the optional removable tip 213, the two battens, right-side batten 206 and left-side batten 208 will be removed, and the victim will have released the grasping handle 210 with the light 211. The victim may then be retrieved aboard the vessel, dock or poolside using a tether 214. The tether is attached to the outer radius of the right-side clamp component 205 near the hinge 215.

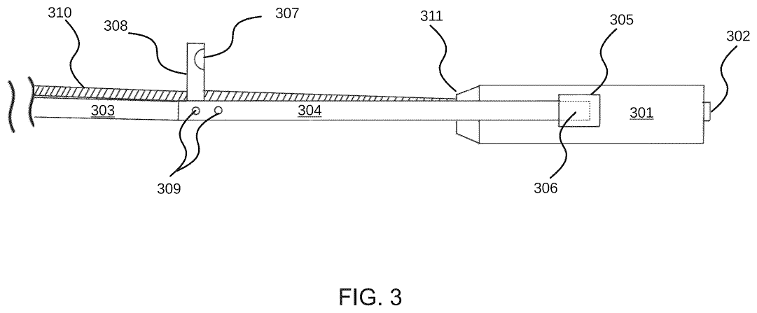

Referring now to FIG. 3, which is being explained for the purpose of providing more details to the interaction between the applicator pole, the at least two battens and the clamp portions, including an optional grasping handle, and the tether. Here, a right-side view of the working parts is illustrated, as follows: The right-side portion of the clamp 301 which is in the closed position with the latch 302 secured. The applicator pole 303 has two spring-back flexible battens configured to mate with the clamp, of which only the right-side batten 304 is visible here.

In this exemplar, the battens are securely affixed to the distal end of the applicator pole 303, (herein shown as secured by two fasteners 309). While the proximal end of the applicator pole 303 is not shown. This right-side batten 304, as with the non-visible left-side batten are releasably inserted into sockets affixed to the clamp components. Here the right-side socket 305 (while the left-side socket is not visible) is shown with the distal end of the right-side batten 306 inserted (as defined by a broken line) into the right-side socket 305 that is mounted on the external radius of the right-side clamp component.

In some embodiments a battery-operated watertight colored LED light 307 may be mounted within a grasping handle 308. This grasping handle 308, which in some embodiments may be brightly colored, when placed within reach of a conscious victim will then be instinctively grasped by the victim. Who when reaching for the grasping handle, will lift their arms and effectively assist in deploying the clamp 301 around their torso, especially if they also instinctively pull the handle towards themselves.

This grasping handle 308 protrudes upwards and orthogonally from the distal end of applicator pole 303 where it meets the base of the flexible battens: the right-side batten 304 visible, and the left-side batten not depicted here. Once the clamp is secured around the torso of the victim with latch 302, the applicator pole 303, along with the two battens, the right-side batten 304 being visible here is removed from the clamp 301.

The distal end of the right-side batten 306 along with the non-visible distal end of the left-side batten will have then been simultaneously withdrawn from their respective sockets (one of which is shown as right-side socket 305), the victim will have let go of the grasping handle 308, and the victim will then be secured within the two hinged and latched portions of the clamp components.

Once the applicator pole 303, the grasping handle 308 and the battens have been withdrawn from the clamp, the clamp will then be solely attached to the retrieval tether 310 at or near the hinge 311. The crew may then hoist the victim aboard in almost any sea conditions. On a small vessel, this may require maneuvering the victim while secured in the clamp 301 to a swim-step at the stern of the vessel. On a double-deck ferry vessel, the crew may put the retrieval tether 310 through a snatch-block that will be attached to the overhead, over the gangway through which passengers are boarded. As used herein, a snatch block is a pulley that can quickly be attached to a fixture on a vessel, and this pulley can be opened to receive a line (or tether) into it without having to lead the end of the line through the pulley. In some circumstances a ratchet pulley may be employed, which would be apparent to a practitioner skilled in the art. In other circumstances, the retrieval tether 310 may be further attached to a crane on a ship and thereby hoist a victim, alive, unconscious or deceased aboard the vessel.

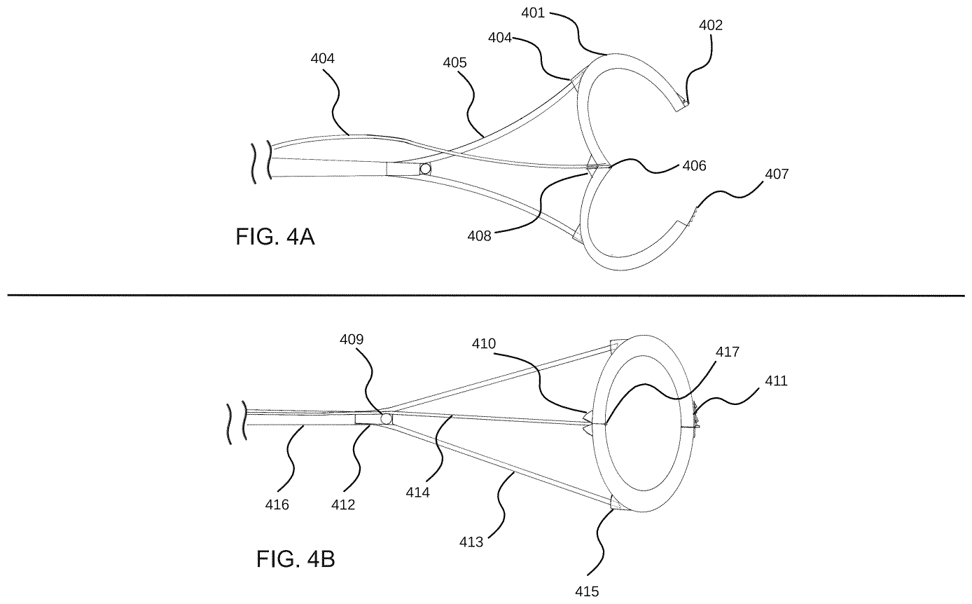

Referring now to FIG. 4A, a clamp (one component of which is shown as 401), is depicted in this exemplar in the fully open position with the stoppers (one of which is shown as stopper 408), preventing it from opening further.

The spring-back flexible battens (one of which is shown as batten 405), are held in the fully open position along with the open clamp such that the inserted batten tips (one of which is shown as batten tip 403), will want to cause the clamp to spring shut once the hinge 406 is pushed against a victim or target and both of the inserted batten tips (one of which is shown as batten tip FIGS. 4B, 415), move past the hinge FIGS. 4A, 406 as shown in FIG. 4A to where the sockets have moved past the hinge FIG. B, 417.

Here the retrieval tether FIGS. 4A, 404 is slack since no tension has yet been applied to additionally cause the hinge point and the spring-back flexible battens to perform as necessary. Additionally, once the distal ends of the clamp components are brought together, the male ratchet latch portion 407 will connect with the female ratchet latch potion 402, to secure the clamp around the victim's torso.

As used herein, a ratchet latch may be composed of a spring-activated ratchet buckle that serves to temporarily secure the first component of a clamp to the second component of a clamp in a method that allows for the ratchet to self-adjust depending on the diameter of the victim's torso. Additionally, as may be apparent to those skilled in the art, the latch may also be magnetically assisted.

Referring again to FIG. 4B. FIG. 4B depicts the clamp in the closed position, with the ratchet latch portions fully engaged as it would be prior to extracting the batten tips from the sockets mounted on outside radiuses of the clamp components (one of which is shown as socket 415). Comparing FIG. 4B to FIG. 4A illustrates how the spring-loaded battens would exert a closing force to the clamp components once the sockets mounted on the outside radiuses of the clamp components are pushed past where the hinge is located.

Additionally, FIG. 4B, depicts an exemplar of what the device would look like once the retrieval tether 414 has been pulled taught against the opposing forces of the inserted batten tips to add additional closing force to the clamp. The spring-back battens (one of which is shown as batten 413), have sprung back to their relaxed position and thereby exert a closing force to the clamp, together with the optional closing force created by device operator who may pull on the retrieval tether to create this force.

Additionally, a grasping handle 409 may be optional and orthogonally mounted on a removable applicator pole tip 412. When a conscious victim reaches out to grab this grasping handle 409, they will instinctively raise their arms, so that the clamp components may be placed into position under the victim's arms and aside their torso. Additionally, once the victim instinctively pulls the handle towards them, the spring-back flexible battens (one of which is shown as batten 413), the victim will provide an additional closing force to the clamp.

The grasping handle 409, together with the applicator pole 416 and the battens configured to mate with the clamp will be removed by an operator from the clamp that has now encircled the victim and has been securely latched to form a clasp 411. The now taught retrieval tether 414 will remain attached near the hinge point 417 and will not be impeded by the now open stoppers (one of which is shown as left-side stopper 410). At this stage, although not shown, the victim will have their torso encircled by the clamp, with the clasp 411 secured, and the rescue clamp operator may remove the applicator pole 416 and withdraw the spring-back flexible battens from their respective sockets (one of which is shown as socket 415), The victim may then be hoisted aboard with the retrieval tether 414 that remains attached to the clamp.

In cases where a victim may have fallen through ice, a rescuer may now use the same procedure to withdraw the applicator pole 416 and battens configured to mate with the clamp (one of which is shown as batten 413). from the rescue clamp that has now been secured around the torso of the victim. The victim may then be pulled out of the water and across the ice to the rescuer.

Referring again to FIG. 4A. In these situations, a first responder will have used a series of extender-poles that may be connected to extend the applicator pole and the open clamp across the ice to where it may encircle the icebound victim.

Those skilled in the art may implement the attachment of additional extender-poles using any methodologies that are apparent to those skilled in the art. Moreover, since the extender-poles, and even the applicator pole, will be supported by the ice across which they lie, the extender-poles may be constructed of aluminum, or be of as simple of a manufacture as PVC plumping pipe, modified and adapted for this purpose.

Once the victim has been secured by the clamp, in a manner analogous to the previous description of attaching the rescue clamp to a victim in a marine environment, the applicator pole and battens will then be removed, and the victim may be pulled from the water and across the ice using an extra-long retrieval tether. A retrieval tether made from Dyneema or Spectra, or other brand of ultra-high-molecular-weight-polyethylene rope, would be of suggested use.

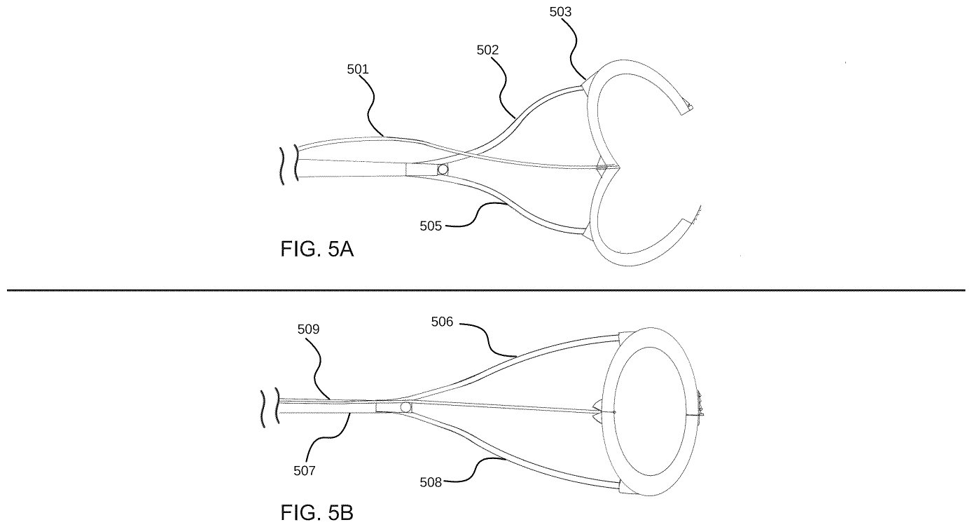

Referring now to FIG. 5A and FIG. 5B, which illustrate an exemplar device where the spring-back flexible battens configured to mate with the clamp have recurve built into them, similar to a recurve archery bow These recurved battens, FIG. 5A, left-side batten 502 and right-side batten 505, configured to mate with the clamp may allow for more pressure to be exerted in order to close the clamp components similar to the increased force generated by a recurved archery bow. A maybe apparent to a person skilled in the art, the battens may also be constructed to be tapered or be constructed to be anisotropic.

As shown previously in FIG. 4A and FIG. 4B, the recurved battens are removably inserted into sockets (one of which is shown as socket FIGS. 5A, 503). These sockets are affixed to the outside radiuses of the hinged clamp components. A retrieval tether FIGS. 5A, 501 is shown in a slack position since no pulling force has been yet applied by the operator at the proximate end of the applicator pole (not shown).

Referring now to FIG. 5B. FIG. 5B shows the spring-back recurved flexible battens, left-side 506 and right-side 508 still inserted in the sockets on the clamp, which is now closed and latched, presumptively around a victim's torso At which point, analogous to the detailed description for FIG. 4B, the battens will be removed from the clamp components and the victim will be rescued at the end of the retrieval tether 509 which is temporarily run alongside the applicator pole 507.

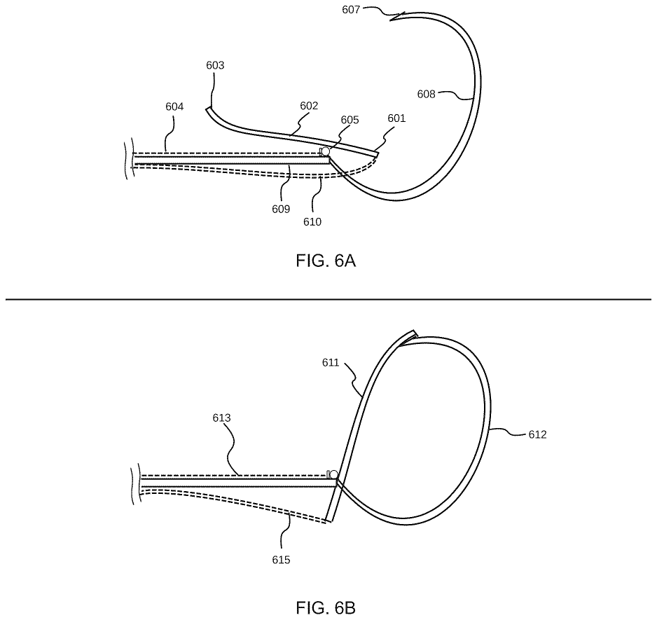

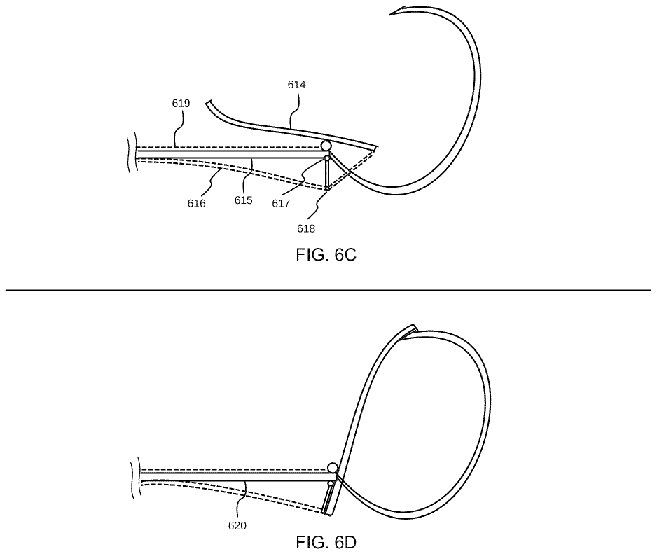

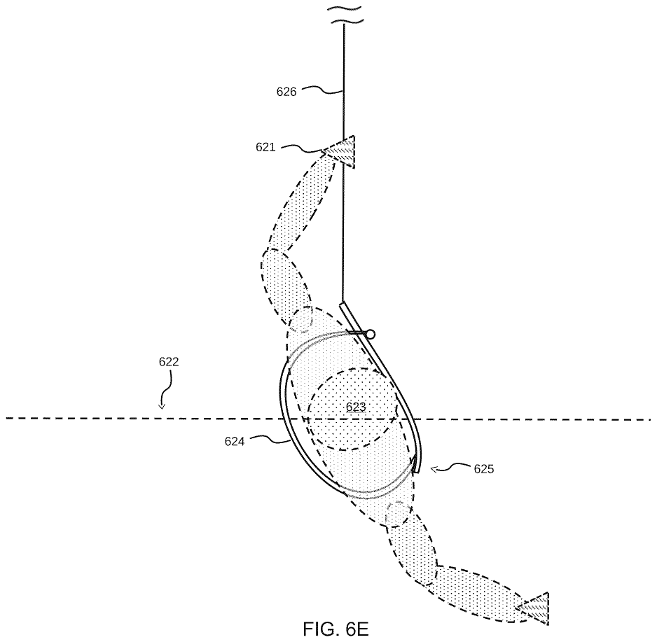

Referring now to FIG. 6A and FIG. 6B. FIG. 6A shows the apparatus in the open position while FIG. 6B shows two clamp components in a latched position. Those skilled in the art may implement the latching of the clamp through various means; for example: 1) using male portion and female receiver portions; 2) using hook and catch receiver portions; 3) using magnet latching or magnetically supplemented latching portions; 3) using hook and eye fabric or hook and eye fabric assisted latching portions.

Additionally, a latching action may be inherent in the design depicted in FIG. 6A and FIG. 6B, as a pulling force is applied to a first end 601 of a latching arm 602 of the clamp, by the operator pulling on the retrieval tether 610. The second end 603 of the latching arm 602 of the clamp will then cause a closing/latching force against the second end 607 of clamp body 608, as the latching arm 602 pivots on a combination hinge and releasing latch. A trigger line 604 that triggers the combination hinge and releasing latch 605 releases the clamp components from the applicator pole 609 is shown running from the combination hinge and releasing latch 605 to where the operator may pull on trigger line (not depicted here). The composition of the combination hinge and releasing latch will be apparent to those skilled in the art and is not illustrated here.

Further, for clarity of view, the exemplar clamps shown in this application are not shown as being padded with floatation materials. However, those skilled in the art may add padding and floatation materials that are apparent to those skilled in the art of floatation devices. In some circumstances floatation material may be composed of buoyant bladder(s) that may be remotely inflated or triggered with trigger lines and inflated with pressurized gas cartridges.

Referring now to FIG. 6B. As soon as this latching is completed, the clamp body 612 together with the now latched lever 611 will be secured around the torso of the victim (not shown here). The rescue clamp operator may then use the trigger line 613 to release the closed clamp from the end of the applicator pole and the victim may then be hoisted from the water by means of the retrieval tether 616.

A sailor or deckhand familiar with hoisting objects aboard a vessel will be familiar with a block and tackle system, including a ratchet version snatch-block that may be attached from the overhead that generally overhangs a multi-deck ferry-boat entrance. This hoisting method will work on multideck tour boats and cruise ships. In the case of commercial vessels: for example, fishing boats, tugboats, cargo vessels, etc., a boom may quickly be deployed to assist in hoisting the retrieval target aboard. These means of recovery once the victim is enclosed in the rescue clamp and attached at the end of the tether will be apparent to those skilled in the art, or this will be apparent to the average experienced mariner. Or the victim may simply be pulled aboard using the retrieval tether.

Referring now to FIG. 6C and FIG. 6D. These figures depict another embodiment of the previous figures, FIG. 6A and FIG. 6B. Here in FIG. 6C an orthogonally attached retrieval tether guide 618 is shown orthogonally attached by a hinge 617 that is attached to the distal end of an applicator pole 615. The retrieval tether 616 runs through a slot in the tip (not illustrated) of the orthogonally attached retrieval tether guide 618 to provide some leverage to the latching arm 614 component of the clamp. A trigger line 619 that releases the clamp components from the applicator pole 609 is shown running parallel to the applicator pole 615 to a location where the operator may pull on it (not depicted here).

FIG. 6D illustrates this exemplar of the apparatus with the clamp components in the closed position (victim not depicted) prior to release from the applicator pole 620.

FIG. 6E depicts a top-down illustration of the application of the rescue clamp exemplars depicted in FIG. 6A, FIG. 6B, FIG. 6C and FIG. 6D once the applicator pole (not shown) has been removed and the hoisting of the victim 623 has begun. The rescue clamp body component 624 is latched 625 to the lever component and secured around the torso of the victim 623 who has their left hand 621 holding onto the retrieval tether 626 that has been pulled taught as the victim 623 is being hoisted out of the water 622 and aboard a vessel (not shown).

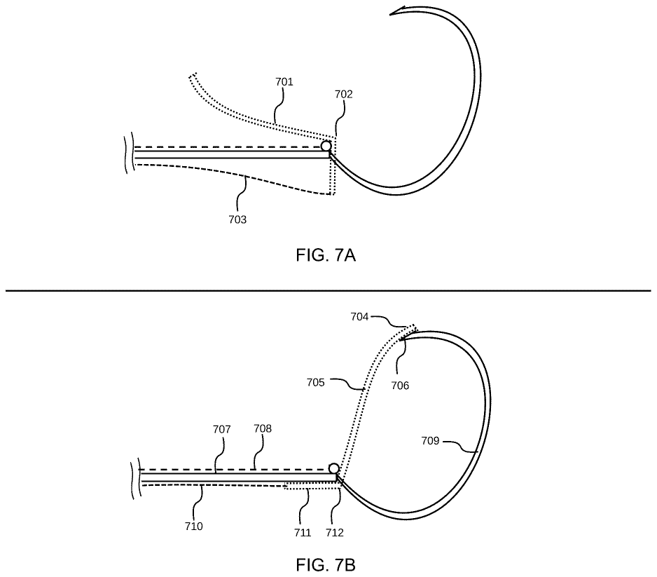

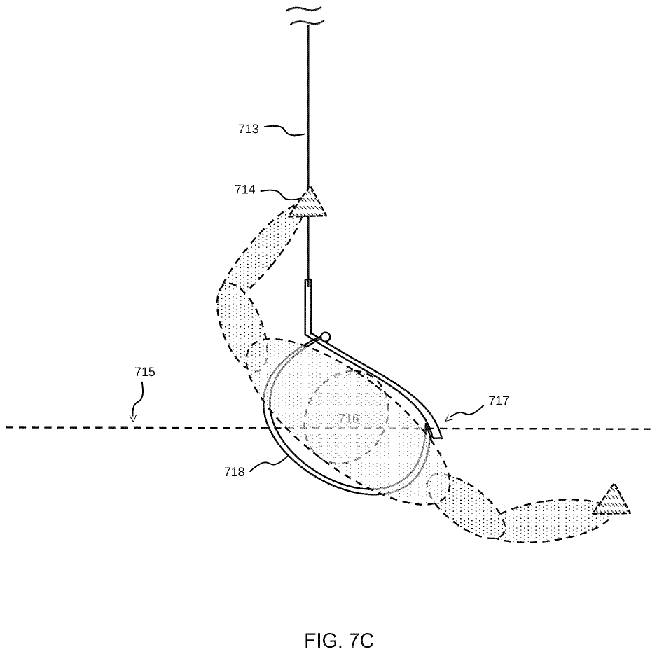

Referring now to FIG. 7A and FIG. 7B. These figures represent another exemplar like those depicted in FIG. 6A, FIG. 6B, FIG. 6C and FIG. 6D. However, here, the bent latching arm portion 701 is shown (depicted with a broken line) with a bend 702 to allow for leverage when pulling on a retrieval line 703 and thereby conveying a closing force to the bent latching arm portion 701 of the rescue clamp. This bend 702 eliminates the need for the orthogonally attached retrieval tether guide 618 as depicted in FIG. 6A and FIG. 6B.

Referring now to FIG. 7B. FIG. 7B shows this exemplar rescue clamp in the secured and latched position, where the latching arm 705 has been latched at its male latch portion 704 to the female latch portion 706 which is attached to the rescue clamp body 709. Thereby encircling the torso of a victim (not shown). The opposite end of the latching arm 711 that is on the other side of the bend 712 in the latching arm is now laying flush to the applicator pole 707, as the retrieval tether 710 has been pulled taught prior to the activation of the trigger line 708 that releases the secured rescue clamp composed of the rescue clamp body 709 and latching arm 705, from the applicator pole.

Referring now to FIG. 7C. FIG. 7C depicts a top-down illustration of the application of the rescue clamp exemplars depicted in FIG. 7A and FIG. 7B once the applicator pole (not shown) has been removed and the hoisting of the victim 716 has begun. The rescue clamp 718 is latched 717 and secured around the torso of the victim 716 who has their left hand 714 holding onto the retrieval tether 713 that has been pulled taught as the victim 716 is being hoisted out of the water 715 and aboard a vessel (not shown).

1. An apparatus for water rescue, comprising:
a clamp composed of at least two components;
an applicator pole being releasably attachable to the clamp; and
a retrieval tether connected to the clamp.

2. The apparatus of claim 1, wherein at least two spring-back battens configured to mate with the clamp are attached to a distal end of the applicator pole.

3. The apparatus of claim 1, wherein at least two curved clamp components defining a hinged clamp having at least one male latch portion and at least one female latch portion respectively attached to distal ends of at least two elongated curved components defining a clamp.

4. The apparatus of claim 1, wherein the clamp is composed of at least two generally equal length elongated curved clamp components that are connected by at least one hinge and are curved to form a circle or an ellipse when secured by at least one male latch portion and at least one female latch portion forming a clasp, and the retrieval tether is connected to the clamp near the at least one hinge.

5. The apparatus of claim 1, wherein the clamp is composed of two equal length elongated curved clamp components that are both padded and buoyant and are connected by at least one hinge and the two equal length elongated curved clamp components are curved to form a circle or an ellipse when secured by a clasp, and a retrieval tether is connected to the clamp near the at least one hinge.

6. The apparatus of claim 1, wherein the clamp is composed of multiple elongated clamp components that are operable using a single mechanism composed of a combination of semiflexible battens and a retrieval tether.

7. The apparatus of claim 1, wherein pushing a hinged portion against an object will apply a force conveying closing element to two portions of the clamp.

8. The apparatus of claim 1, wherein a portion of a proximal end of a releasably attachable applicator pole comprises a textual layer on an exterior surface.

9. The apparatus of claim 1, wherein at least two elongated members forming two spring-back battens are attached to the applicator pole that provide a force conveying element applying a closing force to the clamp composed of two equal length elongated curved clamp components that are hinged and curved and form a circle or an ellipse when secured by a clasp.

10. The apparatus of claim 1, wherein at least two elongated members which are spring-back flexible and are attached to a fixture removably attached to the applicator pole provides a force conveying element applying a closing force to a clamp composed of two equal length elongated curved clamp components that are hinged and curved and form a circle or an ellipse secured by a clasp.

11. The apparatus of claim 1, wherein at least two elongated members which are spring-back flexible are releasably inserted into sockets mounted on outside radiuses of two equal length elongated curved clamp components that are hinged and curved and form a circle or an ellipse when secured by a clasp.

12. The apparatus of claim 1, wherein at least two elongated members which are spring-back flexible, are pre-curved and tensioned to provide a force conveying element applying an additional closing force to two equal length elongated curved clamp components that are hinged and curved and form a circle or an ellipse when secured by a clasp.

13. The apparatus of claim 1, wherein a releasably attachable applicator pole may be extended through a series of additional extender-poles that can be releasably attached to a proximal end of the applicator pole.

14. The apparatus of claim 1, wherein an orthogonal grasping handle is (i) attached to a distal end of a releasably attachable applicator pole and is (ii) located near the connection of at least one proximal end of at least two spring-back flexible elongated members forming battens.

15. The apparatus of claim 14, wherein the orthogonal grasping handle comprises a battery container with a light.

16. The apparatus of claim 14, wherein the orthogonal grasping handle comprises a battery container with a light that is activated by a water-actuated switch.

17. An apparatus, comprising:
a clamp that is releasably attached to an applicator pole,
the clamp composed of at least one first curved elongated member forming a hook shaped clamp body with a first end, attached to a hinge, and a second end with a female latch portion, wherein the clamp is further composed of at least one second elongated member forming a latching arm attached to the hinge with a third end, and a fourth end forming a male latch portion; and,
a retrieval tether attached to the latching arm at the third end, providing a force conveying element to the latching arm.

18. The apparatus of claim 17, wherein the retrieval tether leads from the clamp to at least one quick-release guide point on a releasably attachable applicator pole nearest a distal end of a textual layer.

19. An apparatus comprising:
a clamp composed of at least three elongated components;
an applicator pole being releasably attachable to the clamp; and
a retrieval tether connected to the clamp.

20. The apparatus of claim 19, wherein the applicator pole connected to at least three battens is releasably attachable to sockets mounted on the outside radiuses of at least three elongated clamp components wherein a retrieval tether is attached at or near the hinged proximal ends of the at least three elongated clamp components.
